(19) United States
(12) Patent Application Publication
(10) Pub. No.: US 2020/0085032 A1
(43) Pub. Date: Mar. 19, 2020

(54) ARTICULATION OF ARM SEGMENTS OF A SPRAY BAR

(71) Applicant: POMMIER - SCEBP, Eole-En-Beauce (FR)

(72) Inventors: Frédéric LASNE, Mesnay-Le-Vidame (FR); Nicolas POMMIER, Eole-En-Beauce (FR)

(73) Assignee: POMMIER - SCEBP, Eole-En-Beauce (FR)

(21) Appl. No.: 16/570,007

(22) Filed: Sep. 13, 2019

(30) Foreign Application Priority Data
Sep. 13, 2018 (FR) 1858246

(51) Int. Cl. A01M 7/00

(52) U.S. Cl. CPC A01M 7/0075; A01M 21/043

(57) ABSTRACT

An articulation disposed between two adjacent segments of an arm of a spray bar, including a number of linking members connecting the contiguous ends of two adjacent segments to each other, each linking member being assembled, on the one hand, at one of its ends onto one of said contiguous ends by a ball joint and at its other end onto the other of said contiguous ends by a link allowing, on the one hand, the movement of said linking member with respect to the associated contiguous end in a direction parallel to the longitudinal axis of the associated segment and, on the other hand, the blocking of linking member in a given position.

### FIELD

The present invention relates to the general field of agriculture. It is aimed more precisely at an articulation for arm segments of a bar for spraying or for spreading granules or liquid.

### BACKGROUND

In the field of agriculture, it is known to treat plant cultures in order to combat insects, diseases or weeds, in order to guarantee a good yield of the operation.

To do this, a sprayer, is conventionally used, carried or pulled by a tractor, or self-propelled, and comprising at least:
a tank containing the liquid spray mixture coming from the mixture of phytosanitary product and water,
a bar supporting spray nozzles and depending on the size of the operation and the relief of the terrain, and
a pump pressurising the spray mixture contained in the tank and sucking up the latter in order to send it to the bar and the nozzles, said pump ensuring a homogenous mixture of the spray mixture in order for its concentration to be identical from the beginning to the end of the spraying.

Conventionally, the bars comprise two arms articulated on either side of said tank and each provided with a plurality of segments capable of being folded onto themselves during the movement of the sprayer—tractor assembly on a road, and unfolded perpendicularly to the longitudinal axis of the sprayer in order to spread the spray mixture via spraying onto the plant cultures to be treated.

The main disadvantage of the known bars is related to the folding of the segments of their arms. Indeed, in order to allow the movement of the sprayer—tractor assembly on a road, it is necessary for this assembly to not exceed the regulatory overall dimensions of road vehicle sizes, in particular with regard to the width and height, in order to be able to take all road routes and not be in the category of oversize loads, which would possibly require the use of an accompanying vehicle.

### SUMMARY

The goal of the present invention is to propose an articulation disposed between two arm segments of a spray bar that is robust, easy to implement, allowing at least two folding modes in such a way as to adapt to the regulatory overall dimensions of road vehicle sizes of the place of use of the spray bar.

According to the invention, it is therefore to propose an articulation disposed between two adjacent segments of an arm of a spray bar, remarkable in that it comprises a plurality of linking members connecting the contiguous ends of two adjacent segments to each other, each linking member being assembled, on the one hand, at one of its ends onto one of said contiguous ends by a ball joint and, on the other hand, at its other end onto one of said contiguous ends by a link allowing, on the one hand, the movement of said linking member with respect to the associated contiguous end in a direction parallel to the longitudinal axis of the associated segment and, on the other hand, the blocking of said linking member in a given position.

The articulation advantageously comprises four linking members connecting each end of the upper and lower edges of said contiguous ends of the two adjacent segments of the arm to each other.

Each linking member is preferably a ball comprising a body receiving a bearing bush, a ring capable of pivoting in all three directions inside said bearing bush and a threaded rod extending perpendicularly to the axis of said bearing bush and being associated with at least one nut.

Each ball is thus put in place by placing its body in a clevis and by inserting its threaded rod into a tube, said clevis and tube being respectively fastened onto one of the contiguous ends of two segments.

### BRIEF DESCRIPTION OF THE DRAWINGS

Other advantages and features will be clearer from the following description of a mode of execution of an articulation disposed between two arm segments of a spray bar according to the invention in reference to the appended drawings in which:

FIG. 1 is a perspective view of an arm of a spray bar provided with articulations between its various segments according to the invention;

FIG. 2 is a perspective view of the arm of FIG. 1 folded horizontally;

FIG. 3 is a perspective view of the arm of FIG. 1 folded vertically;

FIG. 4 is a perspective view of the arm of FIG. 1 folded vertically according to another viewing angle;

FIG. 5 is an enlarged detailed perspective view of the end of one of the segments of the arm of FIG. 1 receiving the articulation according to the invention;

FIG. 6 is an enlarged detailed perspective view of the end of the other segment of the arm of FIG. 1 receiving the articulation according to the invention;

FIG. 7 is an enlarged detailed perspective view of the articulation connecting the ends of the segments of the arm of FIGS. 5 and 6;

FIG. 8 is a view of of enlarged face of a linking member of the articulation of FIG. 7;

FIG. 9 is an enlarged cross-sectional view of the linking member of FIG. 8.

### DETAILED DESCRIPTION

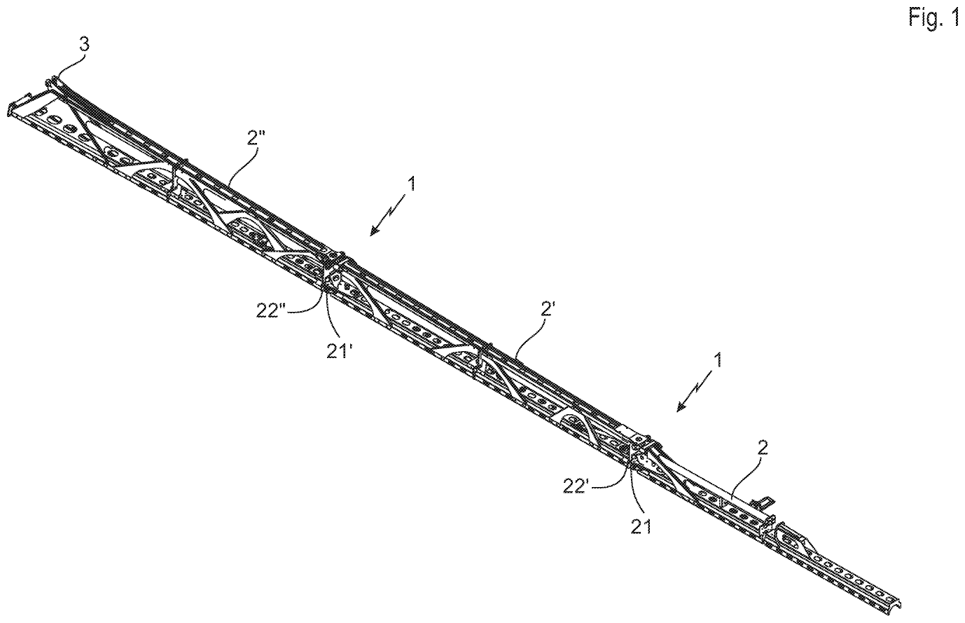

In reference to FIGS. 1 to 8, the invention relates to an articulation 1 disposed between two adjacent segments 2,2′,2″ of an arm 3 of a spray bar, said arm comprising at least segments 2,2′,2″.

Each articulation 1 according to the invention comprises a plurality of linking members 4 connecting the contiguous ends 21,22′; 21′,22″ of two adjacent segments 2,2′,2″ of the arm 3 to each other, each linking member 4 being assembled, on the one hand, at one of its ends onto one 21 or 22′; 21′ or 22″ of said ends 21,22′; 21′,22″ by a ball joint and, on the other hand, at its other end onto the other 22′ or 21; 22″ or 21′ of said ends 21,22′; 21′,22″ by a link allowing, on the one hand, the movement of said linking member 4 with respect to the associated end 22′ or 21; 22″ or 21′ in a direction advantageously parallel to the longitudinal axis of the associated segment 2,2′,2″ and, on the other hand, the blocking of said linking member 4 in a given position.

Each articulation 1 advantageously comprises two linking members 4 connecting each end of one of the vertical edges of said contiguous ends 21,22′; 21′,22″ of the two adjacent segments 2,2′,2″ of the arm 3 to each other, each of the ends of the other vertical edge of one of said contiguous ends 21,22′; 21′,22″ thus advantageously receiving a mechanical stop, not shown, capable of being in contact with the other of said ends 21,22′; 21′,22″ when the arm 3 is in the unfolded position (Cf. FIG. 1).

In reference to FIGS. 8 and 9, each linking member 4 is preferably a ball available on the market comprising a body 41 receiving a bearing bush 42, a ring 43 capable of pivoting in all three directions inside said bearing 42 and a threaded rod 44 extending perpendicularly to the axis of said bearing bush 42 and being associated with at least one nut 45.

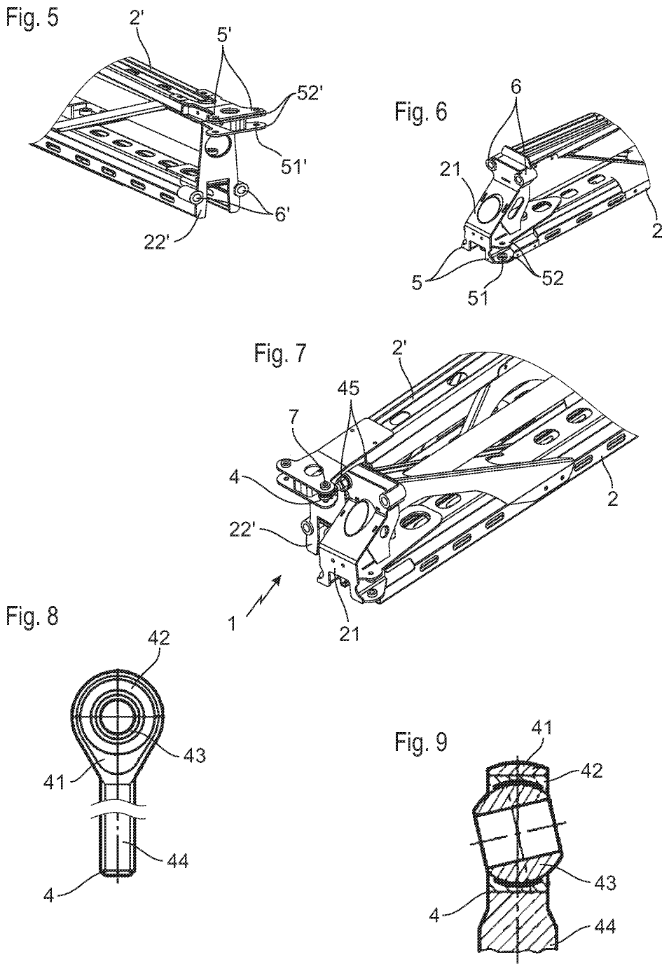

Thus in reference to FIGS. 5 to 7, each ball 4 is therefore put in place by placing its body 41 in a clevis 5,5′ and by inserting its threaded rod 44 into a tube 6,6′, said clevis 5,5′ and tube 6,6′ being respectively fastened onto one of the respective contiguous ends 21,22′; 21′,22″ of two adjacent segments 2,2′,2″ of the arm 3.

In order to maintain the body 41 in place in the associated clevis 5′, the articulation 1 further comprises an axis 7′ capable of being simultaneously inserted into the ring 43 of the ball 4 and into an orifice 51′ made in each of the legs 52′ of said clevis 5′ (Cf. FIG. 7). It goes without saying that an axis, not shown, is also provided at the clevis 5.

Once its threaded rod 44 has been inserted into the tube 6, each ball 4 is immobilised by a nut 45 screwed onto said threaded rod 44 on either side of the tube 6 (Cf. FIG. 7). It is indeed understood that the first nut 45 is screwed onto the threaded rod 44 before the insertion of the latter into the associated tube 6′.

According to an advantageous embodiment, one 21,21′ of the contiguous ends 21,22′; 21′,22″ of two adjacent segments 2,2′2,″ of the arm 3 comprises a tube 6 disposed at each end of its upper edge and a clevis 5 at each end of its lower edge, the other end 22′,22″ thus comprises a tube 6′ disposed at each end of its lower edge and a clevis 5′ at each end of its upper edge.

It goes without saying that the clevis 5,5′ and tube 6,6′ can be disposed in a completely other manner, without going beyond the context of the present invention.

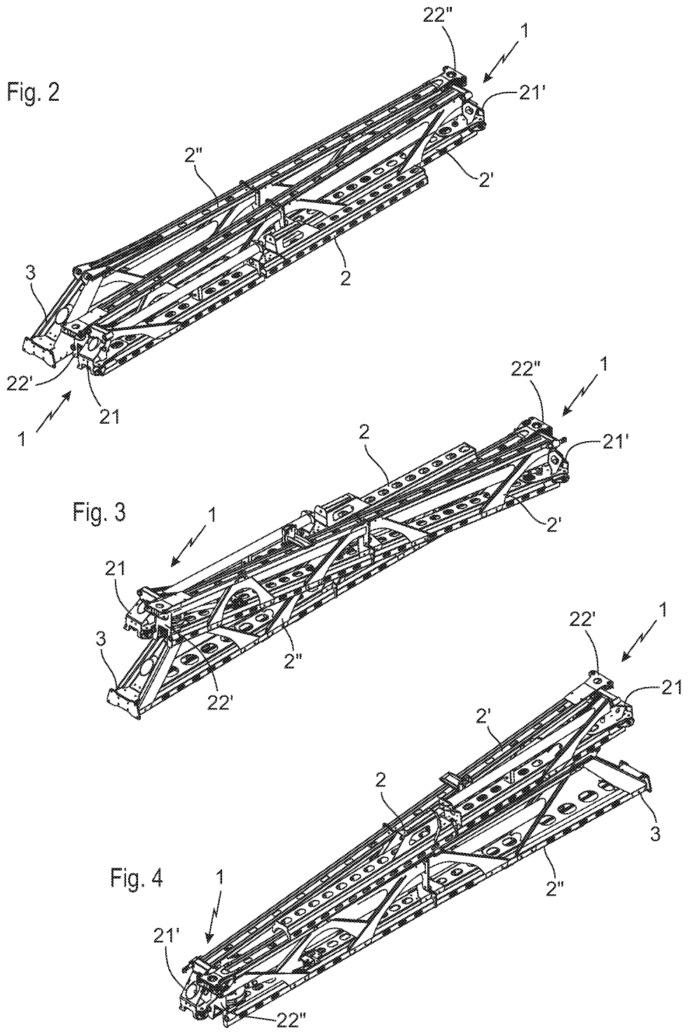

With this configuration of the articulation 1 according to the invention, in order to fold the segments 2,2′,2″ in accordance with FIG. 2, it is necessary, on the one hand, on the articulation 1 disposed between the segments 2,2′ to position the two balls 4 located at each end of one of the vertical edges of the end 21 or 22′ and, on the other hand, on the articulation 1 disposed between the segments 2′,2″ to position the two balls 4 located at each end of the vertical edge of the end 21′ or 22″ located on the opposite side with respect to said vertical edge of the end 21 or 22′.

Thus, the arm 3 can be folded in such a way that the longitudinal axes of the segments 2,2′,2″ generally form a Z when viewed from above, said segments 2,2′,2″ being disposed one after the other, their lower faces thus belonging to the same substantially horizontal plane.

This mode of folding, which is relatively conventional, has the disadvantage of being rather bulky in terms of width.

In reference to FIGS. 3 and 4, the articulation 1 according to the invention has the advantage of allowing to fold the arm 3 in such a way that once the arm 3 has been folded the segment 2 is disposed at least partly above the segment 2″. This mode of folding is of particular interest since it significantly reduces the width of the folded arm 3.

Thus, in order to allow this latter mode of folding, it is necessary, on the one hand, on the articulation 1 disposed between the segments 2,2′ to position the two balls 4 located at each end of one of the vertical edges of the end 21 or 22′ and, on the other hand, on the articulation 1 disposed between the segments 2′,2″ to position the two balls 4 at each end of the vertical edge of the end 21′ or 22″ located on the same side as said vertical edge of the end 21 or 22′.

Then, it is necessary to act on the remaining balls 4 by moving them with respect to their tube 5,5′ in such a way as to move the upper edges of the contiguous ends 21,22′; 21′,22″ of two segments 2,2′,2″ closer together and/or move the lower edges of said ends 21,22′; 21′,22″ away from each other.

These configurations of the balls 4 are preferably set during the manufacturing of the arm 3.

Moreover, the folding/unfolding of the arm 3 is advantageously carried out by cylinders, not shown, rigidly connected between two adjacent segments 2,2′,2″ of said arm 3 and capable of folding or unfolding said adjacent segments 2,2′,2″ until this one of said segments 2,2′,2″ comes in contact, direct or not, with the other segment 2,2′,2″.

The articulation 1 according to the invention applies more particularly to the junction of the segments of an arm of a bar for spraying or for spreading granules or liquid in order to allow their folding/unfolding, but it can also be used in order to allow the pivoting of the arm itself.

Moreover, the articulation 1 according to the invention can also be implemented on any type of arm or device provided with a plurality of segments capable of being folded onto themselves.

Finally, it goes without saying that the examples of articulations 1 according to the invention that have just been described are only specific illustrations, in no case limiting to the invention.

1. An articulation disposed between two adjacent segments of an arm of a spray bar, comprising:
a plurality of linking members connecting the contiguous ends of two adjacent segments to each other, each linking member being assembled, on the one hand, at one of its ends onto one of said contiguous ends by a ball joint and, on an other hand, at its other end onto the other of said contiguous ends by a link allowing, on the one hand, the movement of said linking member with respect to the associated contiguous end in a direction parallel to the longitudinal axis of the associated segment and, on the other hand, the blocking of said linking member in a given position.

2. An articulation according to claim 1, further comprising two linking members connecting each end of the upper and lower edges of said contiguous ends of the two adjacent segments of the arm to each other.

3. An articulation according to claim 1, wherein each linking member is a ball comprising a body receiving a bearing bush, a ring capable of pivoting in all three directions inside said bearing bush and a threaded rod extending perpendicularly to the axis of said bearing bush and being associated with at least one nut.

4. An articulation according to claim 3, wherein each ball is thus put in place by placing its body in a clevis and by inserting its threaded rod into a tube, said clevis and tube being respectively fastened onto one of the contiguous ends of two segments.
